(19) United States
(12) Patent Application Publication
(10) Pub. No.: US 2003/0159905 A1
(43) Pub. Date: Aug. 28, 2003

(54) Method and apparatus for conveying material

(76) Inventors: Kenneth J. Krauss, North Olmsted, OH (US); Phillip G. Brussee, Russell, OH (US); David A. Wiltshire, Seven Hills, OH (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 10/082,265

(22) Filed: Feb. 26, 2002

(51) Int. Cl. B65G 47/04

(52) U.S. Cl. 198/530

(57) ABSTRACT

A device for feeding particulate material includes a conveyor belt, a material inlet located above at least a first portion of the conveyor belt, and a movable plate located above at least a second portion of the conveyor belt, that provides a force on the particulate material.

### FIELD OF THE INVENTION

The present invention relates generally to material feeding devices utilizing a belt conveyer. More particularly, the present invention relates to devices and methods for feeding particulate material, such as for example coal.

### BACKGROUND OF THE INVENTION

In power generation plants that operate by combusting particulate fuel such as coal, it is known to have a feeder device that receives the coal from a downcomer. The coal is stacked in the downcomer, which acts as the outlet of a coal hopper, and enters the inlet of the feeder device. The feeder device transports the coal to a feeder outlet where it exits the feeder device and enters a device such as a pulverizer.

It is desirable for the feeder device to provide some metering of the amount of coal being conveyed. Feeders which are designed to generally control the volume per unit time of coal transport are referred to as “volumetric” feeders. One type of volumetric feeder is a rotary table type feeder, which has the advantage of being compact. However, rotary table feeders require frequent maintenance for replacement of the rotating components.

Another type of volumetric feeder device is a belt type feeder. Such feeders can have an elongated belt conveyer. The coal drops onto the belt from the downcomer near one end of the belt. The coal is transported laterally by the belt, and it passes under a metering plate disposed a set distance above the belt. The metering plate limits the coal height and levels off the top of the coal, and the sides of the coal are confined by side walls, so that a set vertical plane area of coal is being transported under the plate. The feeder can vary the rate of belt transport, thus varying the volume flow rate. After passing under the metering plate, the coal is transported by the belt to the other end of the belt, where is falls off the end and drops down into the pulverizer.

A disadvantage of belt feeders is that where the coal is in a very fluid (easing flowing) state, the gravity force from the stacked coal in the downcomer can urge the coal to flow laterally along the belt in addition to being conveyed by the belt. For example, even if the belt is not traveling at all, coal might tend to slide under the metering plate and across the belt, and even flow off at the outlet. This problem also occurs dynamically during belt travel, so that extra coal might flow through the feeder compared to the amount expected from the conveyer travel speed alone. The particulate coal material may have these fluid properties due to factors such as the particle size and moisture content of the coal.

In order to avoid the free flow problem, belt feeders have been designed to have an elongated belt that is dimensioned to be long enough so that the horizontal belt path resists free coal flow. The belt path is made long enough so that the coal tends to sit on the belt instead of sliding along it. For example, in a typical feeder designed to feed fifteen (15) cubic feet of coal per minute, an example of a belt feeder might have a length measured between the centerline of the downcomer and the outlet of four (4) feet.

In contrast to the belt feeders described above, a rotary table feeder for a comparable fifteen (15) cubic feet per minute feed rate may typically be two (2) feet long and two (2) feet feed wide in overall footprint. Accordingly, it has not been practical to replace these rotary table feeders with belt-type designs due to the longer dimensions of comparable capacity belt-type feeders compared to table feeders.

It would be desirable therefore, to have a belt type feeder that is able to feed coal in a free-flowing or highly fluid state with a constant volumetric rate. It would also be desirable to have a belt-type feeder that can be made more compact than present designs, and that can be sized to be able to replace table type feeders.

### SUMMARY OF THE INVENTION

It is therefor a feature and advantage of the present invention to provide a belt type feeder that is able to feed coal in a free-flowing or highly fluid state with a constant volumetric rate.

It is another feature and advantage of the present invention to provide a belt-type feeder that can be made more compact than present designs.

It is another feature and advantage of the present invention to provide a belt-type feeder and that can be sized to be able to replace table type feeders.

The above and other features and advantages are achieved through the use of a novel conveying apparatus and method as herein disclosed. In accordance with one embodiment of the present invention, a device for feeding particulate material includes a conveyor belt, a material inlet located above at least a first portion of the conveyor belt, and a movable plate located above at least a second portion of the conveyor belt, that provides a force on the particulate material.

In accordance with another embodiment, the invention provides a device for feeding particulate material that includes means for conveying the material in a first longitudinal direction, and means for urging a movable plate against the material to apply a force against the material in a direction other than the first longitudinal direction.

In accordance with another embodiment, the invention provides method for feeding particulate material, in which the material is conveyed in a first longitudinal direction, and a movable plate is urged against the material to apply a force against the material in a direction other than the first longitudinal direction.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a cross-sectional view of a feeder device according to a preferred embodiment of the present invention, taken through section line 1--1 of FIG. 5.

FIG. 2 is a side view the device shown in FIG. 1.

FIG. 3 an end sectional view of the device shown in FIG. 1, taken through section line 3--3 in FIG. 1.

FIG. 4 is a section end section view of the device shown in FIG. 1, taken through section line 4--4 in FIG. 1.

FIG. 5 is an end view of the device shown in FIG. 1.

### DETAILED DESCRIPTION OF PREFERRED EMBODIMENTS OF THE INVENTION

A preferred embodiment of the invention provides a type feeder that is able to feed material in a free flowing or highly fluid state with a substantially constant volumetric rate in some embodiments. This can provide a suitably compact belt-type feeder, which in some embodiments can be sized to be able to replace table type feeders.

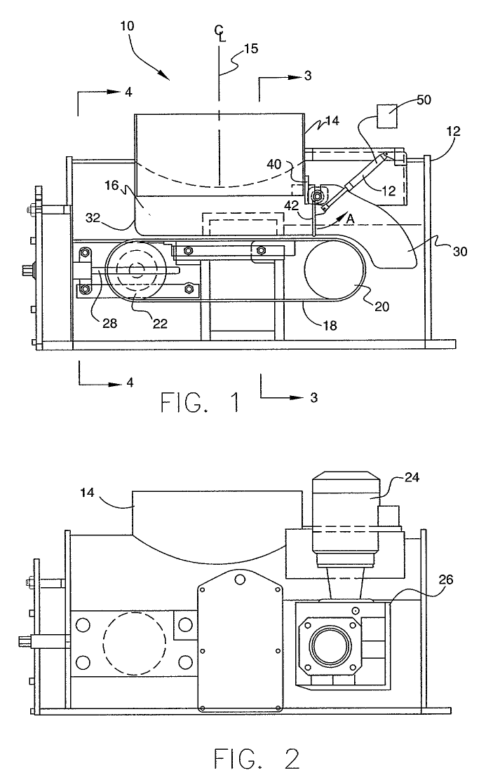

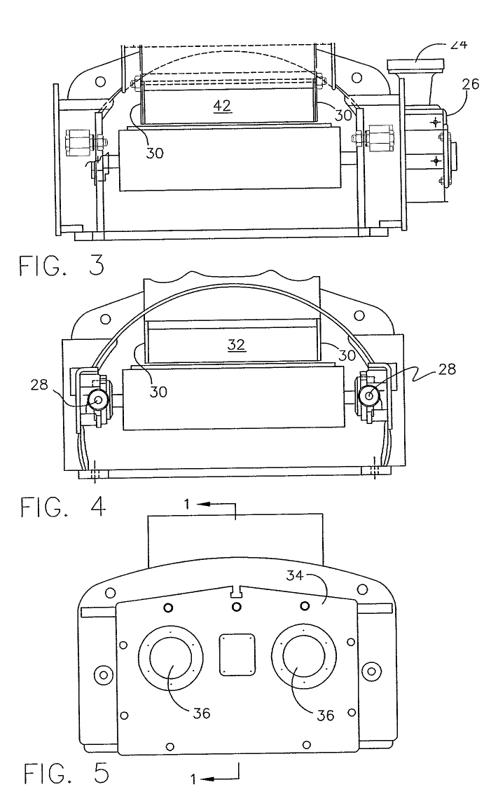

Turning to FIG. 1, the feeder 10 includes a feeder housing 12 located below a feeder inlet pipe 14, commonly referred to as a downcomer with downcomer centerline 45. Coal falls through a hopper in a vertical column through the downcomer 14, and exits the downcomer 14 at the lower opening 16 of the downcomer pipe. This lower opening 16 is also be referred to as a feeder inlet, since it is the location at which coal enters the feeder. It will be appreciated that the coal drops onto a belt 18 which is supported on pulleys 20 and 22. Pulley 20 is driven by a belt drive motor 24 which provides motive power through a drive reducer 26, as seen in FIGS. 2 and 3.

Returning to FIG. 1, in a preferred embodiment, the pulley 20 is the belt drive pulley, and the pulley 22 is a free rotating, belt tension take-up pulley, which may be biased outwardly to support the belt in a desired tension. An external tension takeup pulley adjustment screw 28 may be provided for this purpose.

Turning to FIG. 4, the lower end of the inlet 16, which is defined in part by the bottom of the downcomer pipe 14, also has two lateral inlet side skirts 30, which define the side of a flow path of the coal. The inlet 16 also may have an end inlet in skirt 32, which can be provided to form a back wall to the inlet in some embodiments. FIG. 5 shows the exterior of the device from an end view, and indicates that an end access door 34 may be provided with sight glass ports 36.

Returning now to FIG. 1, it will be appreciated that coal falls through the downcomer 14, and fills the volume bounded by the side inlet walls 30 and rear inlet wall 32 and rests on top of the belt 18. As the belt 18 translates to the right, coal is transported along with the travel of the belt 18 to the right and falls off the belt, to drop into a pulverizer or other piece of equipment. A fixed plate 40 is provided at the edge of the inlet opening spaced above the belt by a predetermined distance. This plate 40 essentially levels off the top of the coal as it is being moved past by the belt, and thus a substantially constant vertical planar area of coal is passing under the metering plate at a given time, therefore, by adjusting the belt speed, a substantially constant volumetric rate of coal can be fed under the plate 40.

In addition to the plate 40, a pivoting door 42 is provided which can pivot upward in the direction A from the position shown. The movement of the coal to the right in FIG. 1 causes the coal to push against the pivoting door 42 so that it is urged to swing upward in the direction A so that coal can pass under the pivoting door 42 and be fed to the right. The pivoting door 42 is connected to a cylinder 44, which provides an opposing force to movement in the direction A and thus provides an opposing force to the door being pushed open by the coal.

The combination of the cylinder 44 and pivoting door 42 provides a resisting force against the movement of coal to the right of FIG. 1 and has been found to suitably at least reduce the problem of free flow of coal that might otherwise occur in the feeder device 10.

The cylinder 44 may be powered by any suitable means, such as pneumatically by air pressure, hydraulically by fluid pressure, by an electric solenoid or electromagnetic device, or by mechanical means such as springs. In a preferred embodiment, the cylinder 44 is air pressurized and the pressure supplied to the cylinder can be controlled by a pressure regulating system 50.

The present invention provides for several modes of operation. In a first mode of operation, the door 42 can be held at a specific angle. The angle can correspond to the lower edge of the door 42 being a specific height above the belt 18. In this mode, the lower edge of the door 42 serves as a final metering plate and can provide for a specific volumetric feed rate. The belt speed can be varied to achieve the desired feed rate. In a second mode, pivoting door 42 can be supplied with a specific pressure which has been found to correspond to be desired volumetric feed rate. In both the first and second modes, it is preferable to use the pivoting door 42 to form the desired cross-sectional area in the vertical plane, and to vary the belt speed to produce the desired volumetric flow rate. However, it can also be possible in some embodiments to run the belt at a constant speed, while dynamically adjusting the angular position on the door 42 in order to provide a change in the volumetric flow rate.

The door 42 can also be used in the position shown in FIG. 1 to provide a overall shutoff device by blocking the flow of coal by particularly when the belt is stopped. Thus, when the belt is stopped a free flow of coal can be prevented by closing the door 42 as shown. This can be accomplished by providing a suitably high pressure through the cylinder 44 via the pressure control system 50.

The embodiment illustrated includes an end skirt 32 at the rear of the inlet. This inlet end skirt 32 prevents coal from escaping in the direction towards the left of FIG. 1. However, this rear end skirt 32 can be omitted if desired. In some embodiments where the end skirt is omitted, it is possible to operate the belt to reverse direction, thereby driving the coal towards the left in FIG. 1. In this reverse feeding direction, the coal is simply fed to the left by the belt and is not affected by the pivoting door 42. This embodiment may be susceptible to the free flowing problem discussed above. However, the reverse operation of urging the coal to the left, and avoiding interaction of coal with the pivoting door 42 may be sometime be desirable. This mode of operation, for example, is useful where the coal is particularly “sticky” and is not tending to free flow at all. Coal in this condition is generally not susceptible to the free flow problem, but sometimes tends to become clogged and bind when pressed upon by the pivoting door 42. Therefore, for this type of coal, operating the belt in the reverse mode can provide desirable volumetric flow characteristics, while avoiding clogging problems at the pivoting door 42.

It will be appreciated that the above embodiments can provide a feeder that is operable at a substantially constant volumetric rate. Also, in some preferred embodiments, the feeder can feed at a volumetric flow rate of fifteen (15) cubic feet per minute and has a distance between the center line of the downcomer and where the coal falls off the belt of one (1) to two (2) feet. These dimensions can permit a feeder device according to an example of the present invention to be installed as a replacement for rotary table feeders.

Although the preferred embodiment is described with reference to feeding coal in a power generation plant, it will be appreciated that the invention may be used to feed other materials and in other applications.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A device for feeding particulate material, comprising:
a conveyor belt that conveys the material in a forward longitudinal direction;
a material inlet located above at least a first portion of the conveyor belt; and
a movable plate located above at least a second portion of the conveyor belt, that provides a force on the particulate material.

2. A device according to claim 1, wherein the plate is mounted for pivotal movement.

3. A device according to claim 1, further comprising a hinge that supports the plate for pivotal movement.

4. A device according to claim 1, further comprising a power actuator that moves the plate.

5. A device according to claim 4, wherein the power actuator is an air cylinder.

6. A device according to claim 4, further comprising a controller that controls the force applied by the plate.

7. A device according to claim 1, further comprising a controller that controls the position of the plate.

8. A device according to claim 1, wherein the plate is mounted for movement to a first position at which the plate substantially prevents movement of coal in the longitudinal direction.

9. A device according to claim 1, further comprising a pair of side skirts extending substantially along at least a portion of the length of the conveyor.

10. A device according to claim 9, further comprising a rear end skirt that extends across the width of the belt located in a rearward direction from the material inlet.

11. A device for feeding particulate material, comprising:
means for conveying the material in a first longitudinal direction; and
means for urging a movable plate against the material to apply a force against the material in a direction other than the first longitudinal direction.

12. A device according to claim 11, further comprising means for supporting the plate for pivotal movement.

13. A device according to claim 11, further comprising a power actuating means for moving the plate.

14. A device according to claim 13, further comprising means for controlling the force applied by the plate.

15. A device according to claim 13, further comprising means for controlling the position of the plate.

16. A method for feeding particulate material, comprising:
conveying the material in a first longitudinal direction; and
urging a movable plate against the material to apply a force against the material in a direction other than the first longitudinal direction.

17. A method according to claim 16, further comprising the step of supporting the plate for pivotal movement.

18. A method according to claim 16, further comprising the step of moving the plate by a power actuator.

19. A method according to claim 16, further comprising the step of controlling the force applied by the plate.

20. A method according to claim 16, further comprising the step of controlling the position of the plate.
